(19) United States
(12) Patent Application Publication
(10) Pub. No.: US 2013/0054744 A1
(43) Pub. Date: Feb. 28, 2013

(54) INFORMATION PROCESSING APPARATUS CAPABLE OF GENERATING URL, METHOD OF CONTROLLING THE INFORMATION PROCESSING APPARATUS, AND STORAGE MEDIUM

(71) Applicant: Masao Akuzawa, Sagamihara-shi (JP)

(72) Inventor: Masao Akuzawa, Sagamihara-shi (JP)

(73) Assignee: CANON KABUSHIKI KAISHA, Tokyo (JP)

(21) Appl. No.: 13/596,221

(22) Filed: Aug. 28, 2012

(30) Foreign Application Priority Data
Aug. 31, 2011 (JP) 2011-188976

(51) Int. Cl. G06F 15/16

(52) U.S. Cl. 709/217

(57) ABSTRACT

An image processing apparatus which is capable of generating URLs for access to Web applications controlled on a port-by-port basis. The information processing apparatus includes a storage unit for storing information. The information processing apparatus controls the storage unit such that port information indicative of a port for access to a Web application is stored. The information processing apparatus acquires the port information indicative of the port for access to the Web application, and generates a URL for access to the Web application, the URL including the acquired port. The generated URL for access to the Web application is registered as a link from another Web application.

### BACKGROUND OF THE INVENTION

1. Field of the Invention

The present invention relates to an information processing apparatus, a method of controlling the same, and a storage medium, and more particularly to an information processing apparatus that registers a URL link for access to a Web application, a method of controlling the information processing apparatus, and a storage medium.

2. Description of the Related Art

Recent MFPs (multi-functional peripherals) are equipped with a Web server function for executing a process in response to a request from each of a plurality of external apparatuses on a network. An MFP equipped with the Web server function executes a Web application that runs on the MFP in response to a processing request received according to the HTTP (Hyper Text Transfer Protocol).

An HTML (HyperText Markup Language) file generated by the Web application often contains a URL (Uniform Resource Locator) link to another Web page. In general, a URL comprises an IP address (or a host name), a port number, a file path, and so forth (see e.g. RFC 1738).

In this connection, there is disclosed a technique of converting the URL of a link destination by referring to an IP address or a host name thereof (see e.g. Japanese Patent Laid-Open Publication No. 2000-285052).

In an apparatus, such as an MFP, whose resources are limited, a plurality of Web applications run on various ports in consideration of security problems.

Further, when registering a URL link in a Web application from another Web application, it is general for an MFP or the like on which run a plurality of Web applications to perform the registration by designating a relative path in which a port number and the like are omitted.

The designation of a relative path is applicable only when Web applications run on the same port.

That is, if link registration based on relative path designation is performed between Web applications which run on respective different running ports, this can cause linking to a wrong link destination or a link error. For this reason, the designation of a URL using a name, such as an IP address or a host name, which is not defined detailed enough, as in the conventional technique, is not applicable to an environment requiring port-by-port control.

### SUMMARY OF THE INVENTION

The present invention provides an image processing apparatus which is capable of generating URLs for access to Web applications controlled on a port-by-port basis, a method of controlling the image processing apparatus, and a storage medium.

In a first aspect of the present invention, there is provided an information processing apparatus including a storage unit for storing information, comprising a storage control unit configured to control the storage unit such that port information indicative of a port for access to a Web application is stored, an acquisition unit configured to acquire the port information for access to the Web application from the storage unit, a generation unit configured to generate a URL for access to the Web application, the URL including the port information acquired by the acquisition unit, and a registration unit configured to register the URL for access to the Web application, which is generated by the generation unit.

In a second aspect of the present invention, there is provided a method of controlling an information processing apparatus including a storage unit for storing information, comprising controlling the storage unit such that port information indicative of a port for access to a Web application is stored, acquiring the port information for access to the Web application from the storage unit, generating a URL for access to the Web application, the URL including the acquired port information, and registering the generated URL for access to the Web application.

In a third aspect of the present invention, there is provided a non-transitory computer-readable storage medium storing a computer-executable program for causing a computer to execute a method of controlling an information processing apparatus including a storage unit for storing information, wherein the method comprises controlling the storage unit such that port information indicative of a port for access to a Web application is stored, acquiring the port information for access to the Web application from the storage unit, generating a URL for access to the Web application, the URL including the acquired port information, and registering the generated URL for access to the Web application.

According to the present invention, the image processing apparatus is capable of generating URLs for access to Web applications controlled on a port-by-port basis.

Further features of the present invention will become apparent from the following description of an exemplary embodiment with reference to the attached drawings.

### BRIEF DESCRIPTION OF THE DRAWINGS

FIG. 1 is a schematic diagram of an information processing system including an MFP according to an embodiment of the present invention.

FIG. 2 is a block diagram of the hardware configuration of the MFP appearing in FIG. 1.

FIG. 3 is a functional block diagram of the MFP appearing in FIG. 1.

FIG. 4 is a diagram of an example of a startup list referred to by an application management section appearing in FIG. 3.

FIG. 5 is a diagram of an example of a servlet registration list managed by the application management section appearing in FIG. 3.

FIG. 6 is a diagram useful in explaining a software configuration for registering URL links.

FIG. 7 is a view of an example of a display by the Web application A having URL links registered therein.

FIG. 8 is a flowchart of a startup process executed by a CPU appearing in FIG. 2.

FIG. 9 is a flowchart of a registration process executed by the CPU appearing in FIG. 2.

FIG. 10 is a sequence diagram showing a registration sequence executed for registering a URL link in the Web application A from a Web application B.

FIG. 11 is a diagram showing URLs generated by a URL complementation section when a Web application C and a Web application D execute the registration sequence.

### DESCRIPTION OF THE EMBODIMENTS

The present invention will now be described in detail below with reference to the accompanying drawings showing an embodiment thereof. In the present embodiment, a description will be given of a case where an information processing apparatus according to the present invention is applied to an MFP (multi-functional peripheral).

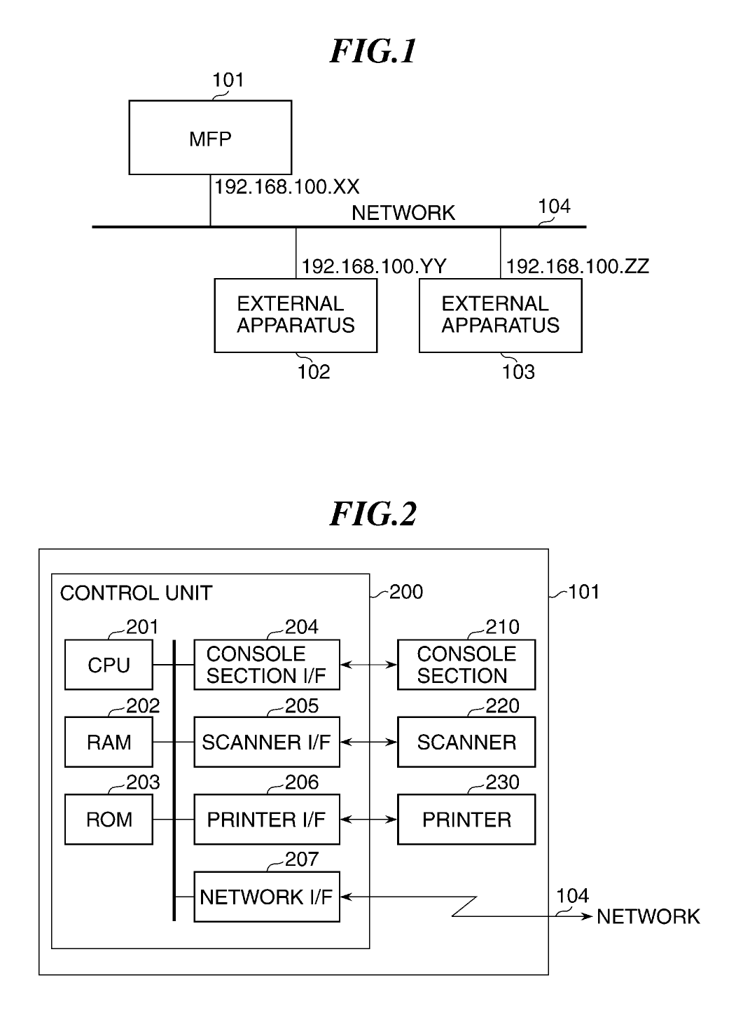

FIG. 1 is a schematic diagram of an information processing system including the MFP 101 according to the embodiment of the present invention.

As shown in FIG. 1, the MFP, denoted by reference numeral 101, and external apparatuses 102 and 103 are intercommunicably connected to a network (LAN) 104. In the present embodiment, the MFP 101 executes a process, described hereinafter, in response to a processing request (hereinafter referred to as “the HTTP request”) sent e.g. from the external apparatus 102 or 103 according to the HTTP (Hyper Text Transfer Protocol). The MFP 101 and the external apparatuses 102 and 103 are assigned respective IP addresses, as shown in FIG. 1.

FIG. 2 is a block diagram of the hardware configuration of the MFP 101 appearing in FIG. 1.

As shown in FIG. 2, the MFP 101 comprises a control unit 200, a console section 210, a scanner 220, and a printer 230.

The control unit 200 comprises a CPU 201, a RAM 202, a ROM 203, a console section interface 204, a scanner interface 205, a printer interface 206, and a network interface 207.

The CPU 201 controls the overall operation of the MFP 101 in a centralized manner. The RAM (random access memory) 202 is a storage unit for storing information, and is used as a work area for the CPU 201, a receive buffer, an image drawing area, and so forth.

The ROM (read only memory) 203 stores software programs to be executed by the CPU 201, and font data. Further, the MFP 101 is provided with a hard disk drive, not shown. This hard disk drive stores an operating system, other system software, and image data.

The console section interface 204 provides interface to the console section 210, for the control unit 200. The scanner interface 205 provides interface to the scanner 220, for the control unit 200. The printer interface 206 provides interface to the printer 230, for the control unit 200. The network interface 207 provides interface to the network 104, for the MFP 101.

The console section 210 comprises various switches and buttons and a liquid crystal display section for message display. The printer 230 performs printing on a recording sheet based on image data. The scanner 220 reads in a printed document or the like and converts the read-in data to electronic data.

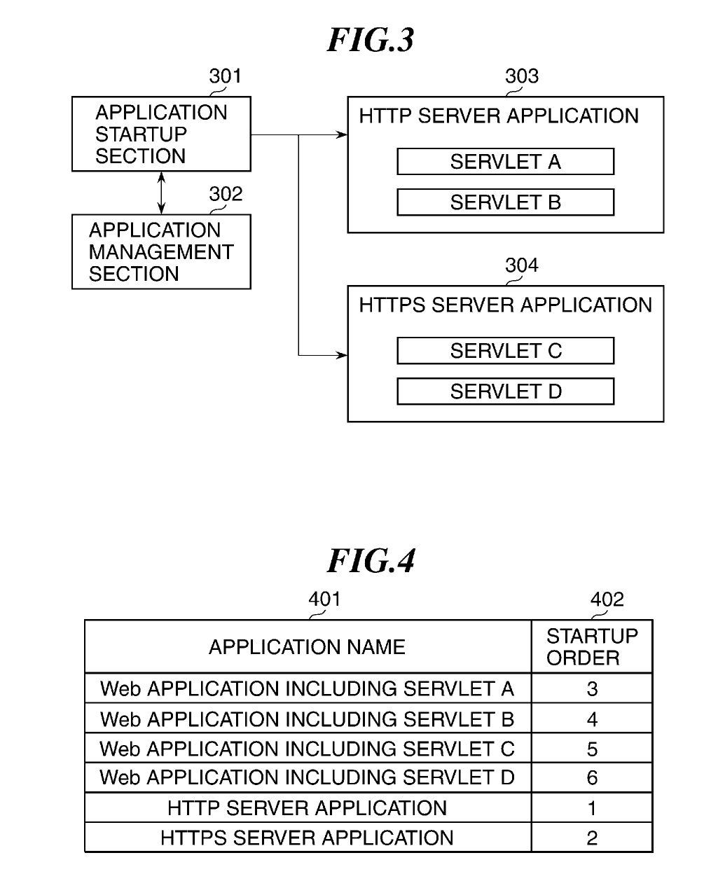

FIG. 3 is a functional block diagram of the MFP 101 appearing in FIG. 1.

Each component described with reference to FIG. 3 can be realized as software or a combination of software and hardware.

The MFP 101 comprises an application startup section 301, an application management section 302, an HTTP server application 303, and an HTTPS server application 304.

The application startup section 301 loads an application program e.g. from the ROM 203 according to an instruction issued from the application management section 302 e.g. when the power of the MFP 101 is turned on or in response to a start instruction from a user, and starts the application program. This application is a Web application and is controlled on a port-by-port basis. A port mentioned here is a port for access to a Web application, in other words, a port on which the Web application runs.

Further, when an HTTP request is received from the external apparatus 102 or 103, the application startup section 301 requests information on an application to be executed, from the application management section 302.

Note that the HTTP request includes identification information for identifying a Web application and a URL expressed using a port number. In the present embodiment, a URL is described in the form of “http://IP address of the MFP 101: port number/servlet path”.

When the MFP 101 receives the HTTP request including the URL, a servlet is called by an application assigned to a designated port number. In other words, an HTTP request is a notification of a request for the execution of a designated application registered in a designated port number.

A servlet is a part of a program code included in an application, and is generally provided for each unit that realizes one function. Thus, an application may include a plurality of servlets.

The application management section 302 notifies the application startup section 301 of an application program to be started and the storage destination of the application program, e.g. an address in the ROM 203, in response to a request from the application startup section 301.

Further, the application management section 302 refers to a startup list e.g. when the MFP 101 is started up, and acquires information on a startup order and the storage destination of each application to be started. The startup list contains information on the startup order of applications and the storage destination of the program code of each application.

The startup list may be generated by the application management section 302 based on information defined by the program header section of each application, when the MFP 101 is started up.

The HTTP server application 303 is a normal HTTP server application. In the illustrated example, it is assumed that servlets A and B are called by the HTTP server application 303.

The HTTPS server application 304 is a HTTP server applications using an SSL socket. In the illustrated example, it is assumed that servlets C and D are called by the HTTPS server application 304.

The application startup section 301 registers servlets to be used in association with port numbers according to information defined e.g. in the respective program header sections of applications, in timing in which the startup list is generated at the startup of the MFP 101.

FIG. 4 is a diagram of an example of the startup list to be referred to by the application management section 302 appearing in FIG. 3.

As illustrated in FIG. 4, the startup list shows application names 401 and a startup order 402 of applications. For example, in FIG. 4, the HTTP server application is started first, and the HTTPS server application is started second.

Thereafter, a Web application including the servlet A, a Web application including the servlet B, a Web application including the servlet C, and a Web application including the servlet D are started in the mentioned order.

These Web applications will be referred to as the Web application A, the Web application B, the Web application C, and the Web application D, respectively.

As described above, in the present embodiment, the startup list defines that the Web applications including the respective servlets are started up after the startup of the HTTP server application 303 and the HTTPS server application 304.

Although not shown in FIG. 4, the startup list further defines the storage destinations of the program codes in association with the respective applications.

When started up, each of the applications including the respective servlets requests the HTTP server application 303 or the HTTPS server application 304 to register the servlet. The registered servlet is recorded in a registration list managed by the application management section 302.

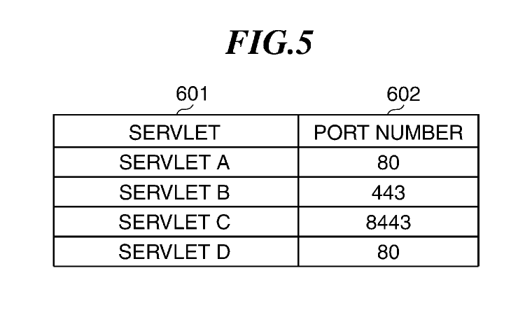

FIG. 5 is a diagram of an example of the servlet registration list managed by the application management section 302 appearing in FIG. 3.

Referring to FIG. 5, in the registration list, reference numeral 601 denotes the names of respective servlets to be registered, and reference numeral 602 denotes port numbers assigned to the respective registered servlets. Note that in FIG. 5, a port number “80” is for HTTP, and port numbers “443” and “8443” are for HTTPS.

In FIG. 5, the servlets A and D are registered in association with the port number “80”, and the servlet B is registered in association with the port number 443. Further, the servlet C is registered in association with the port number 8443.

This registration list is stored in the RAM 202, the hard disk drive, not shown, or a nonvolatile storage device, not shown.

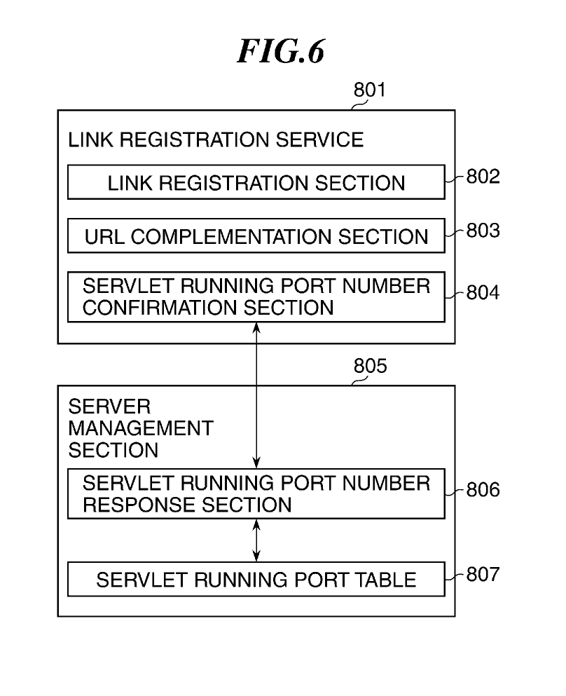

FIG. 6 is a diagram useful in explaining a software configuration for registering URL links.

FIG. 6 illustrates how a URL link is registered in the Web application A.

A link registration service 801 is provided for registering the URL of a Web application requesting link registration, in the Web application A.

The link registration service 801 comprises a link registration section 802, a URL complementation section 803, and a servlet running port number confirmation section 804.

The link registration section 802 associates the URL of the requesting Web application with the Web application A. More specifically, the above-mentioned link information (i.e. the URL of the requesting Web application) is described in an HTML file generated by the Web application A.

The URL complementation section 803 generates a URL from a port number on which the requesting Web application runs, an IP address on which the MFP 101 runs, and the name of a servlet in operation.

The servlet running port number confirmation section 804 inquires of a server management section 805, referred to hereafter, as to the port number on which the requesting Web application is running.

The server management section 805 manages information on servlets operating on the HTTP server application 303 and the HTTPS server application 304.

The server management section 805 comprises a servlet running port number response section 806 and a servlet running port table 807.

The servlet running port number response section 806 receives a request from the servlet running port number confirmation section 804 and sends, as a response, the port number of the port on which the servlet included in the requesting Web application runs to the servlet running port number confirmation section 804. In this response operation, the servlet running port number response section 806 refers to the servlet running port table 807. The servlet running port table 807 stores the registration list illustrated in FIG. 5, in the RAM 202.

Although in the above description given with reference to FIG. 6, it is assumed that the Web application to be registered is a Web application A, this is not limitative. For example, the Web application to be registered may be another Web application or an application that can be operated from the console section 210.

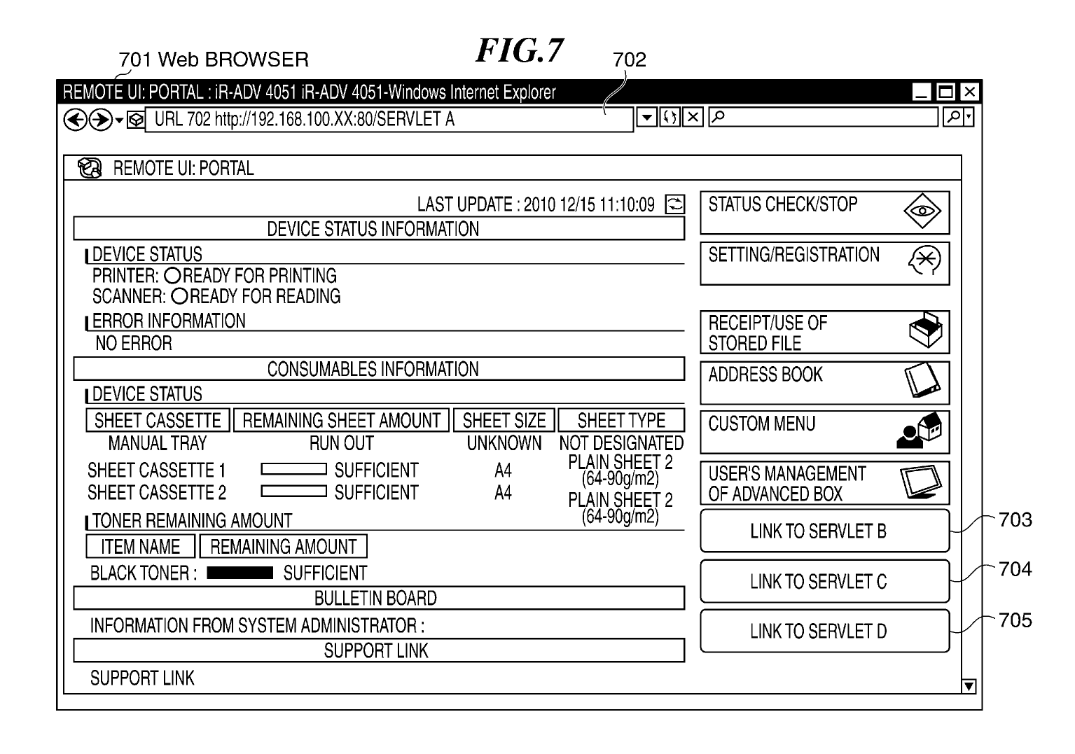

FIG. 7 is a view of an example of a display by the Web application A having URL links registered therein.

Referring to FIG. 7, a Web browser 701 corresponding to the Web application A has not only functions of displaying device status information on the MFP 101 and consumables information, but also a function of displaying link information on links to other Web applications operating in the MFP 101.

Further, a URL link 702 being referred to by the Web browser 701 is displayed on the Web browser 701. Note that a URL designated in the present example is “http://192.168.100.XX:80/servlet A”.

Further, displayed on the Web browser 701 are a URL link 703 to the servlet B, a URL link 704 to the servlet C, and a URL link 705 to the servlet D. The URL link 703 to the servlet B is described in HTML. Specifically, the URL link 703 is described as follows: <a href=http://192.168.100.XX:443/servlet B> link to servlet B</a>.

A user of the Web browser 701 can shift to a Web page generated by the servlet B by selecting the link information. The above-mentioned link information items to respective servlets can be added one by one according to a link information registration process described hereinafter.

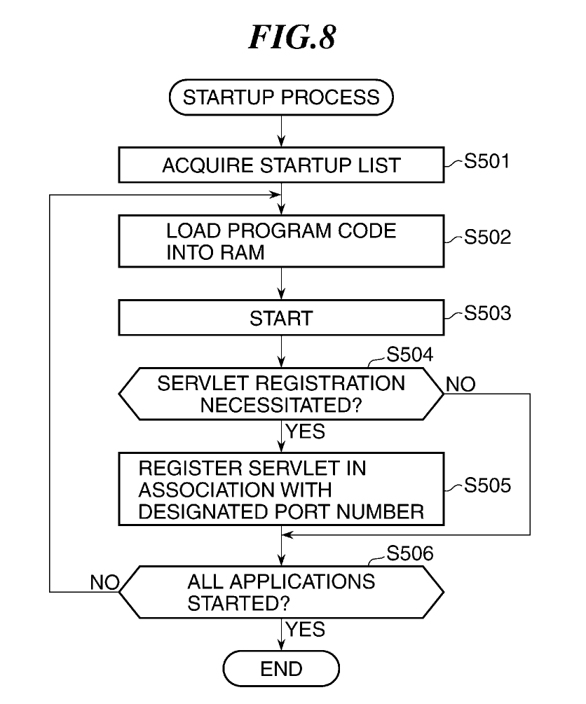

FIG. 8 is a flowchart of a startup process executed by the CPU 201 appearing in FIG. 2.

The present startup process is realized by the CPU 201 by executing an execution program therefor read out from the ROM 203. The process is started when the power of the MFP 101 is turned on or in response to a startup process start instruction from the user.

Referring to FIG. 8, the application management section 302 acquires the startup list stored in the ROM 203 in advance (step S501). Further, the application management section 302 sends information on an application to be started to the application startup section 301 according to the acquired startup list.

Then, the application startup section 301 loads the program code of the application to be started, into the RAM 202 from the ROM 203 according to a startup order designated by the application management section 302 (step S502).

Then, the application startup section 301 executes the program code loaded into the RAM 202, to thereby start the application (step S503).

Then, the application startup section 301 determines whether or not servlet registration is necessitated (step S504). Specifically, by executing the application program, if an API for servlet registration has been called from the program code, the application startup section 301 determines that servlet registration is necessitated. Note that API is an acronym for Application Programming Interface.

If it is determined in the step S504 that servlet registration is not necessitated (NO to the step S504), the process proceeds to a step S506. On the other hand, if it is determined in the step S504 that servlet registration is necessitated (YES to the step S504), the application startup section 301 registers a servlet in association with a designated port number (step S505). The step S505 corresponds to a storage control unit configured to control a storage unit such that port information indicative of a port for access to a Web application is stored.

Then, the application startup section 301 determines whether or not all the applications defined in the startup list have been started (step S506). If it is determined in the step S506 that all the applications have been started (YES to the step S506), the present process is terminated. On the other hand, if not all the applications have been started (NO to the step S506), the process returns to the step S502.

In FIG. 8, a method of registering a servlet according to whether or not the API has been called from a program code executed by the application startup section 301 is described by way of example.

However, the present invention is not limited to this method, but the application management section 302 may generate a servlet registration list in advance and pass the registration list to the application startup section 301 together with the startup list in timing synchronous with the startup of an application, for example. In this case, registration of a URL link in a Web application is performed using the received servlet registration list.

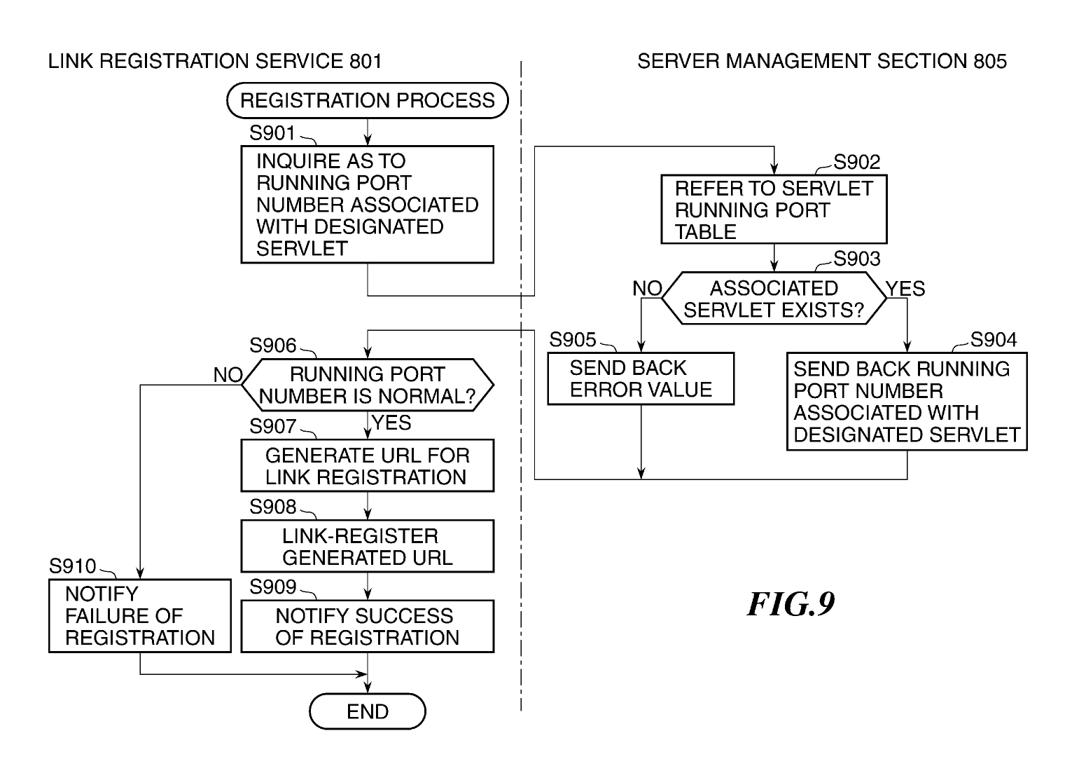

FIG. 9 is a flowchart of a registration process executed by the CPU 201 appearing in FIG. 2.

The present registration process is realized by the CPU 201 by executing an execution program therefor read out from the ROM 203. This process is started in response to a URL link registration request from a Web application.

Referring to FIG. 9, the link registration service 801 inquires of the server management section 805 as to a running port number associated with a servlet designated by a Web application requesting link registration, via the servlet running port number confirmation section 804 (step S901).

Then, the server management section 805 refers to the servlet running port table 807 via the servlet running port number response section 806 (step S902). The step S902 corresponds to the operation of an acquisition unit acquisition unit configured to acquire port information (port number) for access to a Web application, from the storage unit.

The server management section 805 determines, based on the result of the reference, whether or not an associated servlet exists (step S903). If it is determined in the step S903 that no associated servlet exists (NO to the step S903), the server management section 805 sends back an error value (e.g. −1) (step S905), and the process proceeds to a step S906.

On the other hand, if it is determined in the step S903 that an associated servlet exists (YES to the step S903), the server management section 805 notifies the link registration service 801 of the running port number of the designated servlet (step S904). For example, if the servlet B is designated, the number “443” is sent as a running port number to the link registration service 801.

Then, the link registration service 801 determines whether or not the running port number received from the server management section 805 is normal (step S906).

If it is determined in the step S906 that the running port number is not normal (NO to the step S906), the link registration service 801 notifies the requesting Web application that the link registration is not successful (step S910), followed by terminating the present process. The error value is “−1” as mentioned above, and a normal running port number corresponds to a positive value. Therefore, whether or not a running port number is normal can be determined from the sign of a value received as a response.

On the other hand, if it is determined in the step S906 that the running port number is normal (YES to the step S906), the link registration service 801 generates a URL for link registration via the URL complementation section 803 (step S907). The step S907 corresponds to a generation unit configured to generate a URL for access to a Web application, which includes port information (port number) acquired by the acquisition unit.

Specifically, e.g. when link registration for registering the servlet B of the Web application B is executed for the Web application A, an URL “http://192.168.100.XX:443/servlet B” is generated.

Then, the link registration section 802 registers the generated URL in the Web application on which the link registration service 801 operates (step S908) and notifies the requesting Web application that the link registration is successful (step S909), followed by terminating the present process.

In the step S908, the link registration section 802 registers the generated URL as “a href=http://192.168.100.XX:443/servlet B>link to servlet B</a>” as a link.

As described above, in the registration process, a servlet name is notified to the server management section 805 from a requesting Web application, whereby an appropriate URL is generated. When a running port number is intentionally sent from the requesting Web application in addition to the servlet name, the link registration service 801 may generate the URL without inquiring the running port number of the server management section 805.

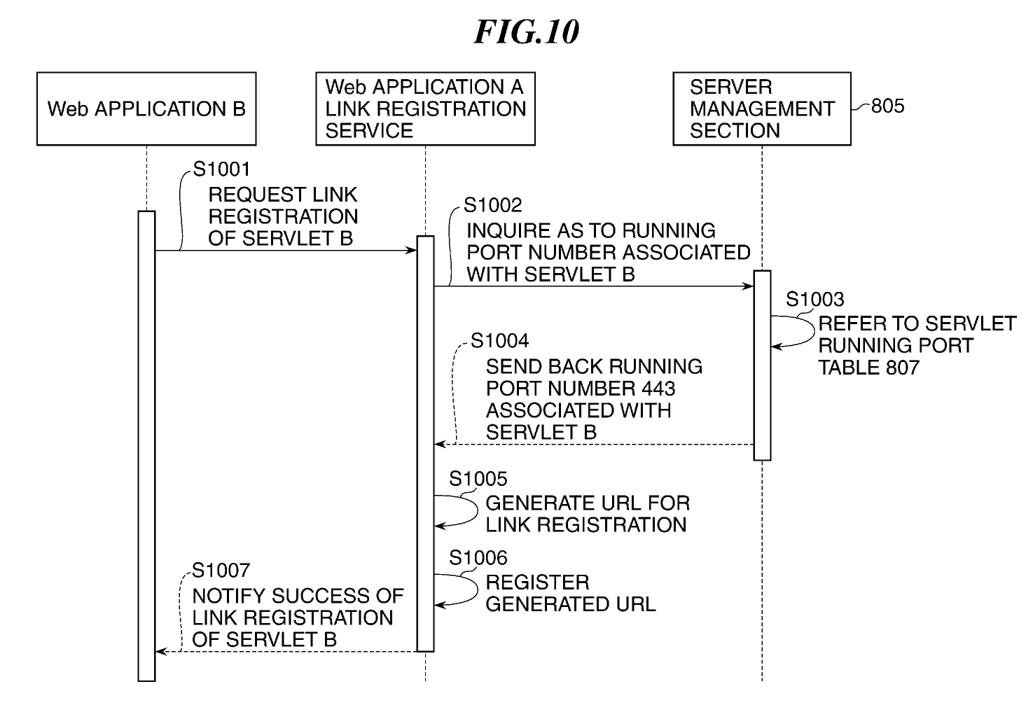

FIG. 10 is a sequence diagram showing a registration sequence executed for registering a URL link in the Web application A from the Web application B.

In the illustrated example, it is assumed that the servlet B has already been registered in the HTTPS server as shown in FIG. 5.

The Web application B requests the link registration service 801 of the Web application A to execute link registration of the servlet B (step S1001). Then, the link registration service 801 inquires of the server management section 805 as to the running port number of the servlet B (step S1002). In doing this, the servlet running port number confirmation section 804 of the link registration service 801 requests the server management section 805 to confirm existence of a running port of the servlet B.

The server management section 805 calls the servlet running port number response section 806 to send back a port number on which the servlet B is running. The servlet running port number response section 806 refers to the servlet running port table 807 (step S1003).

In the present example, it is assumed that existence of the running port of the servlet B is confirmed by referring to the servlet running port table 807, and the server management section 805 sends the number “443” as a running port number to the link registration service 801 (step S1004).

The link registration service 801 calls the URL complementation section 803 to generate a URL to be registered in the Web application A (step S1005). At this time, the URL complementation section 803 generates the URL “http://192.168.100.XX:443/servlet B” described with reference to FIG. 9.

Then, the link registration section 802 registers the generated URL as “a href=http://192.168.100.XX:443/servlet B>link to servlet B</a>” as a link, as described hereinabove (step S1006).

Then, the link registration service 801 notifies the Web application B that the link registration of the servlet B is successful (step S1007), followed by terminating the present process.

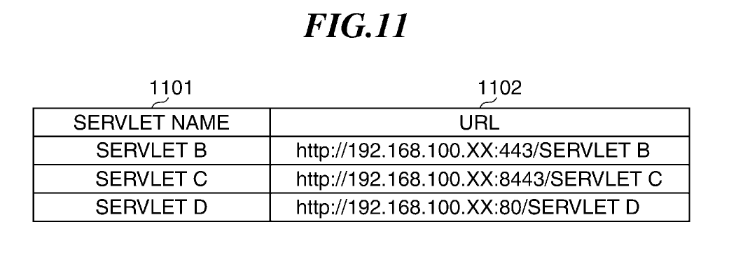

FIG. 11 is a diagram showing URLs generated by the URL complementation section 803 when the Web application C and the Web application D execute the registration sequence.

Reference numeral 1101 denotes names of servlets to be registered in the Web application A, and reference numeral 1102 denotes servlet URLs generated by the URL complementation section 803. It is understood by referring to the URLs associated with the respective servlets that a URL is generated in the following form: http://an IP address at which a Web application as a link destination runs: a port on which the servlet of a Web application as a link source runs/servlet name.

As described above, a Web application that performs link registration of the URL of a servlet in another Web application can appropriately perform the link registration by having the URL appropriately corrected by the URL complementation section 803.

This enables a requesting Web application to register a URL link irrespective of a running port number of a Web application to be registered without the user being conscious of the running port number.

As a consequence, even if a running port of the Web application to be registered is changed from a port for HTTP to a port for HTTPS so as to improve security, it is possible to use an application without modifying the application, which contributes to improvement of the portability of an application.

In the above-described embodiment, when a port for access to a Web application is changed, port information indicative of the changed port may be stored.

Further, a URL may be generated using a relative path including a port number. Further, in the present embodiment, a URL is generated according to the IP address of an apparatus on which a Web application runs.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2011-188976 filed Aug. 31, 2011, which is hereby incorporated by reference herein in its entirety.

What is claimed is:

1. An information processing apparatus including a storage unit for storing information, comprising:
a storage control unit configured to control the storage unit such that port information indicative of a port for access to a Web application is stored;
an acquisition unit configured to acquire the port information for access to the Web application from the storage unit;
a generation unit configured to generate a URL for access to the Web application, the URL including the port information acquired by said acquisition unit; and
a registration unit configured to register the URL for access to the Web application, which is generated by said generation unit.

2. The information processing apparatus according to claim 1, wherein when the port for access to the Web application is changed, said storage control unit controls the storage unit to store port information indicative of the changed port.

3. The information processing apparatus according to claim 1, wherein said generation unit generates the URL using a relative path.

4. The information processing apparatus according to claim 1, wherein said generation unit generates the URL according to an IP address of an apparatus on which the Web application runs.

5. A method of controlling an information processing apparatus including a storage unit for storing information, comprising:
controlling the storage unit such that port information indicative of a port for access to a Web application is stored;
acquiring the port information for access to the Web application from the storage unit;
generating a URL for access to the Web application, the URL including the acquired port information; and
registering the generated URL for access to the Web application.

6. A non-transitory computer-readable storage medium storing a computer-executable program for causing a computer to execute a method of controlling an information processing apparatus including a storage unit for storing information,
wherein the method comprises:
controlling the storage unit such that port information indicative of a port for access to a Web application is stored;
acquiring the port information for access to the Web application from the storage unit;
generating a URL for access to the Web application, the URL including the acquired port information; and
registering the generated URL for access to the Web application.
